(19) United States
(12) Patent Application Publication
(10) Pub. No.: US 2008/0013748 A1
(43) Pub. Date: Jan. 17, 2008

(54) ELECTRONIC DEVICE CAPABLE OF SWITCHING BETWEEN DIFFERENT OPERATIONAL MODES VIA EXTERNAL MICROPHONE

(75) Inventors: Sung-Kai Yang, Sinjhuang City (TW); Yu-Hsi Lan, Jhubei City (TW); Shien-Neng Lai, Shenkeng Township (TW)

Correspondence Address: THOMAS, KAYDEN, HORSTEMEYER & RISLEY, LLP, 600 GALLERIA PARKWAY, STE 1500, ATLANTA, GA, 30339, US

(73) Assignee: FORTEMEDIA, INC., Cupertino, CA (US)

(21) Appl. No.: 11/623,111

(22) Filed: Jan. 15, 2007

(30) Foreign Application Priority Data
Jul. 17, 2006 (TW) 95126036

(51) Int. Cl. H04R 3/00

(52) U.S. Cl. 381/92

(57) ABSTRACT

An electronic device comprises a body, a first microphone, and a second microphone. The first microphone is disposed in the body. The second microphone is detachably connected to the body. The first and second microphones constitute a microphone array to receive sound from a predetermined direction when the second microphone is connected to the body.

### BACKGROUND OF THE INVENTION

1. Field of the Invention

The invention relates to an electronic device capable of switching between different operational modes via an external microphone.

2. Description of the Related Art

Portable consumer electronic or communications devices, such as cellular phones, personal digital assistants (PDA), global positioning system (GPS) receivers, portable computers, and others, often comprise an internal omni-directional microphone to receive sound. The omni-directional microphone, however, receives sound from all directions including background noise. Thus, the quality of sound received by the omni-directional microphone is often poor.

### BRIEF SUMMARY OF THE INVENTION

The invention provides an electronic device capable of switching between different operational modes via an external microphone to improve the quality of received sound.

The electronic device of the invention comprises a body, a first microphone, and a second microphone. The first microphone is disposed in the body. The second microphone is detachably connected to the body. The first and second microphones constitute a microphone array to receive sound from a predetermined direction when the second microphone is connected to the body.

The first microphone may be an omni-directional microphone. The second microphone may be a unidirectional microphone. The electronic device receives sound from all directions when not connected to the second microphone, and avoids environmental noise, clearly receiving sound from a predetermined direction when connected to the second microphone.

The invention also provides a method of receiving sound, comprising receiving sound from all directions by an omni-directional microphone; constituting a microphone array of the omni-directional microphone and a uni-directional microphone; and receiving sound from a predetermined direction by the microphone array.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 depicts an electronic device in accordance with a first embodiment of the invention;

FIG. 2 depicts operation of the electronic device of FIG. 1;

FIG. 3 depicts an electronic device in accordance with a second embodiment of the invention;

FIGS. 4A and 4B depict operation of the electronic device of FIG. 3;

FIG. 5 depicts an electronic device in accordance with a third embodiment of the invention; and

FIG. 6 depicts operation of the electronic device of FIG. 5.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

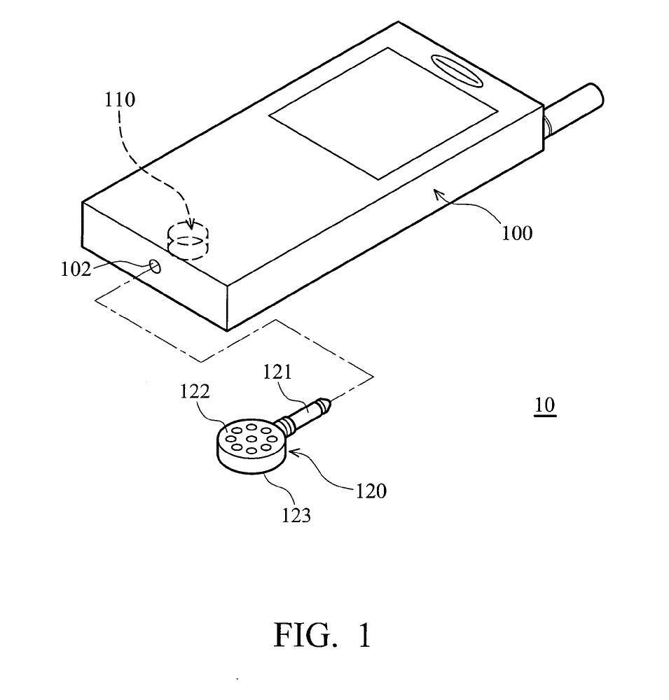

Referring to FIG. 1, an electronic device 10 in the first embodiment of the invention is a cellular phone comprising a body 100, a first microphone 110, and a second microphone 120.

The body 100 comprises a sound input jack 102.

The first microphone 110 is disposed in the body 100 and is an omni-directional microphone.

The second microphone 120 is a uni-directional microphone and comprises a front side 122, a back side 123, and a metal plug 121.

The electronic device 10 is capable of switching between different operational modes via the second microphone 120:

To receive sound omni-directionally, electronic device 10 receives sound via first microphone 110 in the body 100. First microphone 110 is an omni-directional microphone and thus receives sound from all directions.

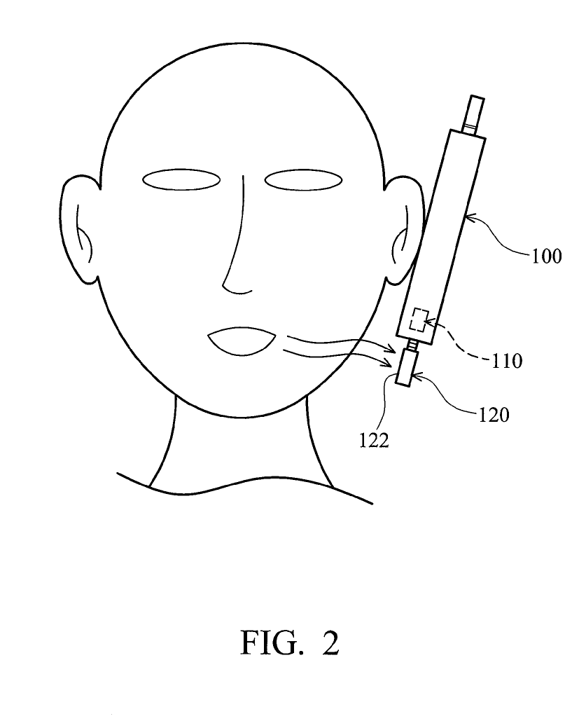

To receive sound uni-directionally, metal plug 121 of the second microphone 120 is inserted into the sound-input jack 102 of the body 100. Upon detecting the second microphone 120, the electronic device 10 changes to receive sound by both of the first and second microphones 110 and 120 which constitute a microphone array. The direction of the microphone array is determined by the front side 122 of the second microphone 120. The metal plug 121 of the second microphone 120 serves as a first shaft, allowing rotation of the second microphone 120. As shown in FIG. 2, in loud environments, the front side 122 of the second microphone 120 is directed away from the environment. The microphone array avoids environmental noise and clearly receives desired sound.

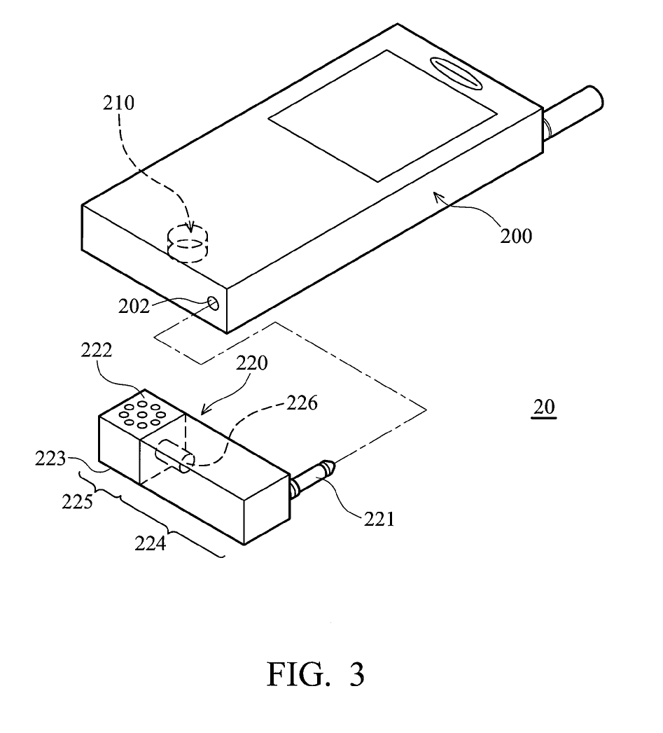

Referring to FIG. 3, an electronic device 20 in the second embodiment of the invention is also a cellular phone comprising a body 200, a first microphone 210, and a second microphone 220.

The body 200 comprises a sound input jack 202.

The first microphone 210 is disposed in the body 200 and is an omni-directional microphone.

The second microphone 220 is a uni-directional microphone and comprises a first part 224, a second part 225, a first shaft (i.e. metal plug) 221, and a second shaft 226. The first shaft 221 protrudes from the first part 224. The second part 225 is connected to the first part 224 through the second shaft 226. The second shaft 226 is substantially perpendicular to the first shaft 221. The second part 225 comprises a front side 222 and a back side 223. The direction of the second microphone 220 is determined by the front side 222.

Similarly, the electronic device 20 is capable of switching between different operational modes via the second microphone 220:

To receive sound omni-directionally, electronic device 20 receives sound by the first microphone 210 in the body 200. The first microphone 210 is an omni-directional microphone and thus receives sound from all directions.

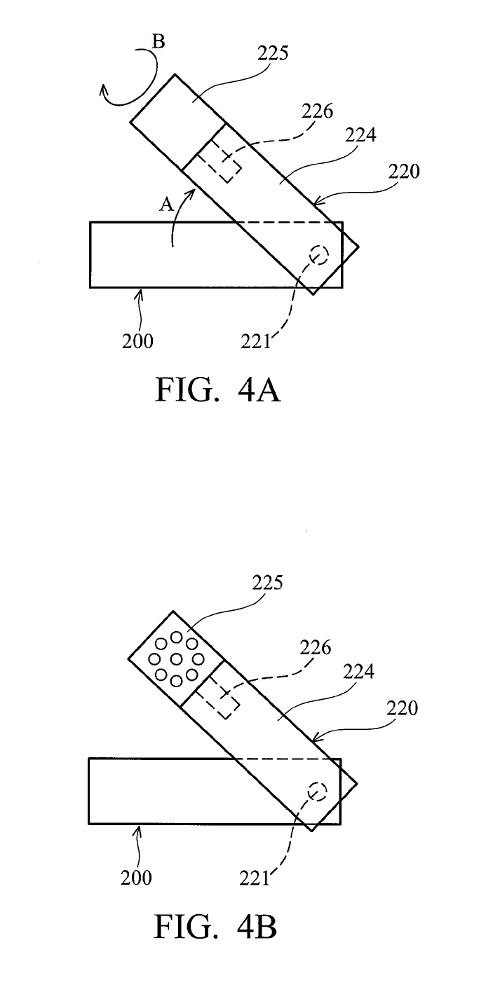

To receive sound uni-directionally, first shaft (metal plug) 221 of the second microphone 220 is inserted into the sound-input jack 202 of the body 200. Upon detecting the second microphone 220, the electronic device 20 changes to receive sound by both of the first and second microphones 210 and 220 which constitute a microphone array. The second microphone 220 is rotatable via the first shaft 221 and the second shaft 226, allowing the user to direct the front side 222 of the second microphone 220 toward the target sound source. As shown in FIG. 4A, for example, the second microphone 220 is rotated about an axis A via the first shaft 221 and the second part 225 is rotated about an axis B via the second shaft 226. In FIG. 4B, the microphone array thus receives sound from the direction perpendicular to the paper.

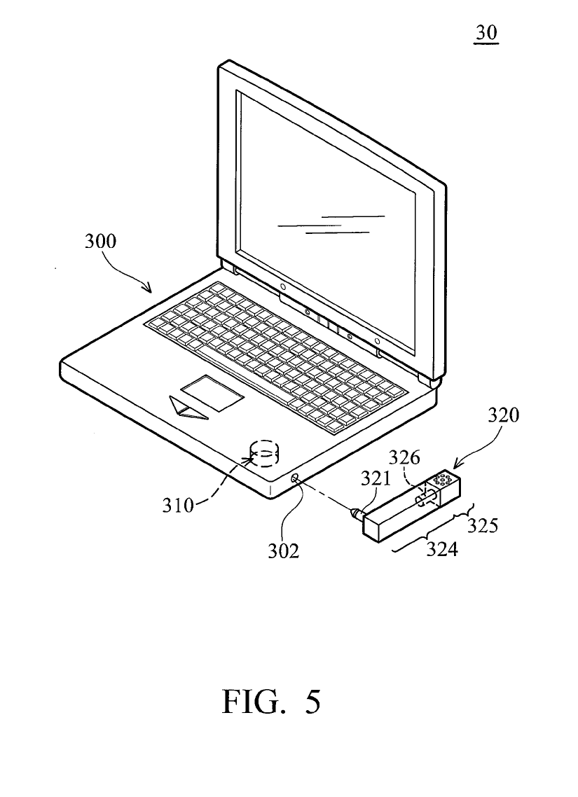

Referring to FIG. 5, an electronic device 30 in the third embodiment of the invention is a portable phone comprising a body 300, a first microphone 310, and a second microphone 320.

The body 300 comprises a sound input jack 302.

The first microphone 310 is disposed in the body 300 and is an omni-directional microphone.

The second microphone 320 is a unidirectional microphone and comprises a first part 324, a second part 325, a first shaft (i.e. metal plug) 321, and a second shaft 326. The first shaft 321 protrudes from the first part 324. The second part 325 is connected to the first part 324 through the second shaft 326. The second shaft 326 is substantially perpendicular to the first shaft 321.

Similarly, the electronic device 30 is capable of switching between different operational modes via the second microphone 320:

To receive sound omni-directionally, electronic device 30 receives sound by the first microphone 310 in the body 300. The first microphone 310 is an omni-directional microphone and thus receives sound from all directions.

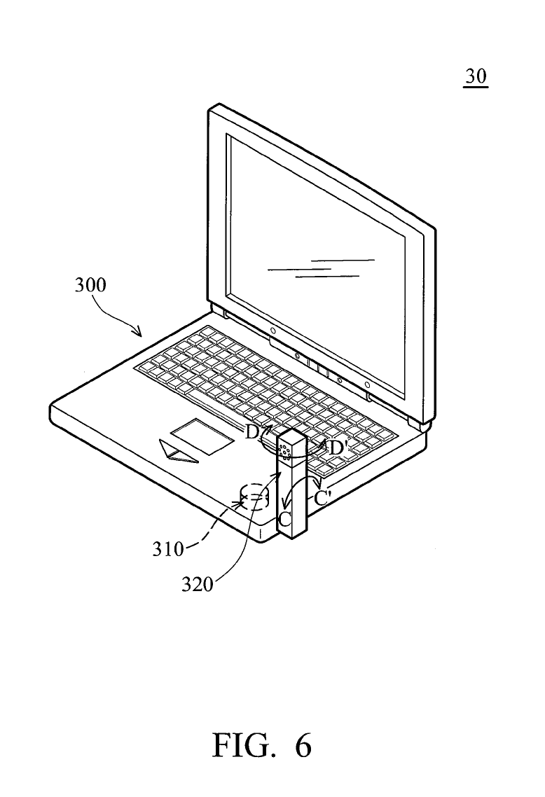

To receive sound omni-directionally, first shaft (metal plug) 321 of the second microphone 320 is inserted into the sound-input jack 302 of the body 300. Upon detecting the second microphone 320, the electronic device 30 changes to receive sound by both of the first and second microphones 310 and 320 which constitute a microphone array. The second microphone 320 is rotatable via the first shaft 321 and the second shaft 326 to receive sound from the target sound source. As shown in FIG. 6, for example, the second microphone 320 can be rotated in direction C or C′ via the first shaft 321 and rotated in direction D or D′ via the second shaft 326 to receive sound from different directions.

In the above embodiments, a cellular phone and a portable computer have been introduced. It is understood, however, that the invention is applicable to a personal digital assistant (PDA), a global positioning system (GPS) receiver, and other electronic devices.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An electronic device, comprising:
a body;
a first microphone disposed in the body; and
a second microphone detachably connected to the body, wherein the first and second microphones constitute a microphone array when the second microphone is connected to the body.

2. The electronic device as claimed in claim 1, wherein the first microphone is an omni-directional microphone.

3. The electronic device as claimed in claim 1, wherein the second microphone is a uni-directional microphone.

4. The electronic device as claimed in claim 1, wherein the second microphone comprises a first shaft through which the second microphone is connected to and rotatable with respect to the body.

5. The electronic device as claimed in claim 4, wherein the first shaft is a metal plug, and sound signal received by the second microphone is output to the body through the metal plug when the metal plug is inserted into the body.

6. The electronic device as claimed in claim 4, wherein the second microphone further comprises a second shaft around which the second microphone is rotated.

7. The electronic device as claimed in claim 6, wherein the second shaft is substantially perpendicular to the first shaft.

8. The electronic device as claimed in claim 1, wherein the electronic device is a cellular phone.

9. The electronic device as claimed in claim 1, wherein the electronic device is a personal digital assistant.

10. The electronic device as claimed in claim 1, wherein the electronic device is a portable computer.

11. The electronic device as claimed in claim 1, wherein the electronic device is a global positioning system receiver.

12. A method of receiving sound, comprising:
receiving sound from all directions by an omni-directional microphone;
constituting a microphone array of the omni-directional microphone and a uni-directional microphone; and
receiving sound from a predetermined direction by the microphone array.

13. The method of receiving sound as claimed in claim 12, further comprising changing an angular position of the uni-directional microphone.

14. A uni-directional microphone, comprising:
a first part;
a first shaft protruding from the first part;
a second shaft; and
a second part connected to the first part through the second shaft wherein the second part is rotatable with respect to the first part.

15. The uni-directional microphone as claimed in claim 14, wherein the first shaft is substantially perpendicular to the second shaft.
